(19) United States
(12) Patent Application Publication
(10) Pub. No.: US 2002/0165956 A1
(43) Pub. Date: Nov. 7, 2002

(54) Traffic driven scheduling of active tests

(76) Inventor: Peter Phaal, San Francisco, CA (US)

Correspondence Address: Vincent K. Yip, McCutchen, Doyle, Brown & Enersen, LLP, 18th Floor, Three Embarcadero Center, San Francisco, CA, 94111, US

(21) Appl. No.: 09/850,202

(22) Filed: May 7, 2001

(51) Int. Cl. G06F 15/173

(52) U.S. Cl. 709/224; 709/238

(57) ABSTRACT

A network monitoring system having a router for generating flow records and a monitor device for filtering flow records, extracting internet address information of the remote hosts from the flow records and performing active tests on selected remote hosts. For at least some data packets, the router sends a flow record of the data packet to the monitor. Each flow record contains address, port, and subnet information of the filtered data packet. Based on the information provided by the flow records, the monitor can perform active tests on the selected remote hosts.

### BACKGROUND OF THE INVENTION

The invention relates generally to monitoring a network, and more particular, to monitoring network traffic of remote hosts scattered throughout the Internet.

Efficient transfers of data between a main server system and remote hosts require a high bandwidth capability. At one time, a 14.4 kbps connection was believed to provide sufficient bandwidth for most users connected to a server system. However, adding graphics, video and/or audio files to text files certainly taxes the capability of such a connection. Moreover, the popularity of Internet applications, such as the World Wide Web, has threatened to overload the capacity of existing communication lines.

Industries have introduced technologies and equipment to address bandwidth concerns. Cable operators and telephone carriers offer broadband data services via local access networks (e.g., ADSL, ISDN, Cable and wireless LMDS) to residential subscribers in order to provide the subscribers with direct, high-speed access to a variety of local community content, such as bulletin boards, news, and advertisements. In addition, the local access networks provide the residential subscribers with availability to commercial on-line service providers and the global Internet. Integrated Services Digital Network (ISDN) connections reach transfer speeds of 128 kbps and cable modems reach speeds of 10 Mbps.

A data access system is comprised of a main server and a high speed network that connects the main server to remote hosts scattered in the Internet. The main server may include content servers that store data for transfer to the remote hosts. In an Internet environment, the main server typically utilizes Internet applications, such as electronic mail, bulletin boards, news groups, and World Wide Web access. In addition to on-premises servers, a data access system may control access to remote hosts.

In general, network throughput monitoring is of interest to data service operators. In conventional local area data networks, several tools have been developed for monitoring data transfer throughput. Typically, the tools assess achievable throughput by simulating traffic on the network. There are at least two known types of active throughput testing tools. A first type of active throughput testing emulates data transfers over the TCP/IP protocols and can be executed from the server to measure downloading rates and/or from the premises of a subscriber to measure uploading rates. Tools of this type include Netperf, throughput TCP, and Traceroute Reno (treno). The second type of active throughput testing tool emulates typical user accesses to measure throughput to selected Web servers. Such a tool is disclosed by Anacapa Software entitled “NetScore Intelligent Agent Tracks Users Response Time to Intranet/internet Servers, File Servers, IP Hosts and SNA Mainframes.”

In order to determine the network traffic on a site-by-site basis, the simulated traffic must be sent to or received from each site. In order to perform these tests, one must select a target host to perform the test against. There are a millions of hosts on the Internet. Selecting a set of hosts to test is a difficult problem. The overhead of traffic generation grows proportionally with the number of remote hosts that must be monitored. Perhaps more importantly, during high network loads the additional traffic imposed on the network for active monitoring can drastically reduce throughput to and from the remote hosts and can result in inaccuracies in the throughput measurements. Another concern is that these monitoring approaches require support for special applications at the servers and/or subscriber sites, solely for the purpose of monitoring throughput.

A round-trip delay measurement approach that is referred to as “non-intrusive” is described in U.S. Pat. No. 5,521,907 to Ennis, Jr. et al. Separate probes are positioned at selected monitoring points along a communication network. The probes receive identifiable data patterns normally transmitted over the communications network and generate a time stamp when each of the identifiable data patterns arrives at or leaves the selected monitoring point. Each probe also generates a pattern-identifier that is based on the data in the pattern. The pattern identifier and the time stamp are stored as a pair in an internal buffer. After the internal buffers of the two probes exceed a predetermined amount of data, a processor receives the data from the buffers and matches the pattern-identifiers of the two buffers. The matches locate the departure and arrival time stamps of each pattern traveling between the two monitoring points. The processor then calculates an average of round-trip delay or travel times based on the departure and arrival time stamps of several patterns traveling in both directions between the probes.

While the Ennis, Jr. et al. approach operates well for its intended purpose, the method requires probes to be connected at each site to which monitoring is to be implemented. Thus, each remote site must include a probe and its circuitry if the approach is to enable site-by-site evaluation. Moreover, since the approach requires a processor to match the patterns and compare the time stamps, the patterns and time stamps of at least one of the probes must be transmitted to the processor. This requires that the communication lines be utilized for the transmission. Consequently, a portion of the limited resources of the communications network being monitored must be temporarily dedicated to the monitoring process. Importantly, the throughput achievable on the network cannot be estimated based upon round-trip times alone. Since the method of Ennis, Jr. et al. only considers specific packets and not all packets, and since this method does not take into account packet retransmissions and other characteristics of the transport protocol (e.g., timeout delays), the method cannot directly be used for throughput measurements which refer to the rate of useful data delivery.

### SUMMARY OF THE INVENTION

It is therefore an object of the present invention to provide a network monitoring system.

It is another object of the present invention to provide a network monitoring system being able to automatically select target sites for monitoring.

It is yet another object of the present invention to provide a network monitoring system that monitors only the most active network paths.

The present invention discloses a network monitoring system having a router for generating flow records and a monitor device for filtering the flow records, extracting the internet address information of the remote hosts from the filtered flow records and performing active tests on the selected remote hosts. For at least some data packets, the router sends a flow record of each selected data packet to the monitor. Each flow record contains address, port, and subnet information of the filtered data packet. Based on the information provided by the flow records, the monitor can perform active tests on selected remote hosts.

Additional objectives, features and advantages of various aspects of the present invention will become apparent from the following description of its preferred embodiments, which description should be taken in conjunction with the accompanying drawings.

### BRIEF DESCRIPTIONS OF THE DRAWINGS

FIG. 1 illustrates a sample ping process.

FIG. 2 illustrates a sample traceroute process.

FIG. 3 shows a preferred embodiment of the monitoring system according to the present invention

FIG. 4 shows a sample flow record.

FIG. 5 shows details of a test scheduling algorithm according to the present invention.

FIG. 6 shows a clean-up task running periodically in the monitor.

### DETAILED DESCRIPTION OF THE PREFERRED EMBODIMENTS

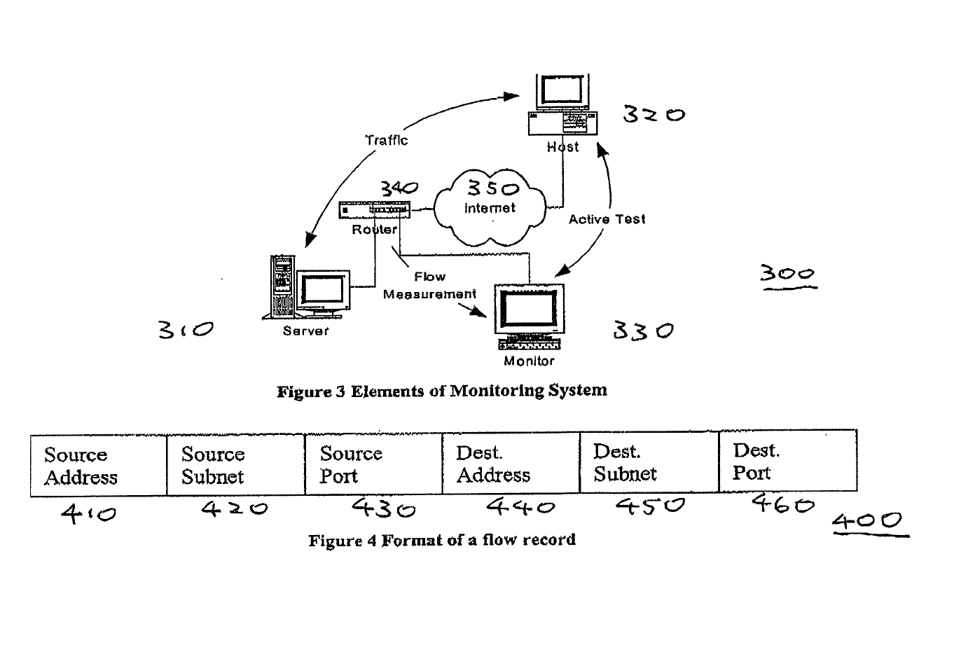

FIG. 3 shows a preferred embodiment of the network monitoring system 300 according to the present invention. The monitoring system 300 as shown comprises a main server 310 connected to a remote host 320, a router 340 connected between the main server 310 and the Internet 350, and a monitor 330 coupled to the router 340. The figure characterizes the paths between a main server and remote hosts scattered throughout the Internet. This design is typical for sites hosting web servers, where the hosted web servers are accessed by a large number of hosts scattered throughout different locations in the Internet. According to this embodiment, the router 340 filters the data packets coming in and from the hosted servers 310. For each filtered data packet, the router 340 generates and sends a “flow record” containing the destination and source information of the data packet to the monitor 330 for further analysis and testing. The monitor 330 then can randomly select at least a fraction of the flow records received from the router 340 and extracts the destination and source information from the selected flow records. Using the source and destination information, the router can perform active network tests to the remote hosts. The test results are then gathered and analyzed.

According to another embodiment of the present invention, instead of having the router 340 filter the data packets and generate the flow records for the filtered data packets, the router 340 generates a flow record for every data packet passing through it. The flow records are sent to the monitor 330 for filtering. In this embodiment, the monitor 330 filters the flow records by examining the addresses, port, and/or subnet information embedded in the flow records. It should be noted that, even though the filtering step is essential, the step is optional. In the case that the monitor 330 does not filter the flow records, the monitor 330 can still perform active network tests on the remote hosts indicated by the Internet addresses of the flow records.

In one embodiment of the present invention, most of the filtering happens in the monitor 330, not the router 340. The router 340 is configured to generate flow records for certain interfaces, but then generates flow records for all flows through those interfaces. For example, in the case of Cisco NetFlow, it will be all TCP/IP flows. On the other hand, in the case of InMon's sampling technology, it will be a random sample of all data packets forwarded to or from that interface. The monitor is responsible for determining whether the flow is of interest by determining whether a flow goes off site (many flows maybe entirely local and so will be ignored). The monitor may also filter the flow records so that only certain applications (such as web, or email) are considered. Further filtering could be based on the actual server involved. Typically servers from many different customers will be hosted together. The performance analysis may be a value added service, and only certain hosts will trigger tests.

According to present invention, the monitor 330 keeps a list of subnets, addresses or router ports that are local to the site. This enables the monitor 330 to determine the remote address from a flow. Flows can be examined to determine whether the source or destination information relates to a remote host.

In the preferred embodiment, the flow records can be generated by the flow sampling technology disclosed by U.S. patent application Ser. No. 09/745,260, titled “Method to Associate Input and Output Interfaces with Packets Read from a Mirror Port” filed on Dec. 20, 2000 by the same inventor of the present invention, and/or U.S. patent application Ser. No. 09/438,680, titled “Intelligent Collaboration Across Network System” filed on Nov. 12, 1999 by the same inventor of the present invention and Cisco NetFlow network monitoring system. The abovementioned two patents applications are hereby incorporated by reference in its entirety.

FIG. 4 shows a sample flow record 400 according to the present invention. The flow record as shown contains source and destination addresses 410,440, subnets 420,450 and ports 430,460. The source and destination addresses 410,440 represent the Internet addresses of the source and the destination of the monitored data packet. The source and destination subnets 420,450 represent the subnet of the source and destination of the monitored data packet. The source and destination ports 430,460 represent the port number of the source and destination of the monitored data packet. Depending on the designs of the flow record generating device, some fields of the flow record may be missing, or additional fields may be available.

It should be noted that, according to the present invention, it is not necessary for each flow record to contain both the source and destination information. For example, if all the filtering are done on the router, then just the remote addresses are sufficient. However, most conventional routers do not have the ability to do the filtering. Also it is useful to have full flow information at the monitor. While only part of the information is needed to schedule the tests, the rest of the information is useful for interpreting the results. For example, to understand which customer, servers, services etc. were affected by poor performance to a remote subnet.

When a data packet passes through the router, the router generates a flow record for the data packet. After the flow record is generated, the router sends the flow record to the monitor. As shown in FIG. 4, the flow record sent to the monitor contains the source and destination addresses, port numbers and subnet information for the data packet passing through the router. By examining the information contained in each flow record, the monitor can filter the flow records to select records corresponding to flows between selected external hosts and local servers. Then the monitor randomly samples the filtered flow records and selects a predetermined fraction of the records for further analysis. The monitor then extracts the Internet information of a target of interest from each flow record. In general, the target of interest is a remote host coupled with the main server. In other cases, the target of interest can be local or non-local host coupled with the main server. After the Internet information is extracted from the flow record, the monitor performs an active test between the monitor and the remote host identified in the flow record. According to the present invention, the monitor can perform a ping test and/or a traceroute test using the remote host information. The results of the test can be recorded for later analysis.

According to the preferred embodiment of the present invention, two types of active test can be performed by the monitor:

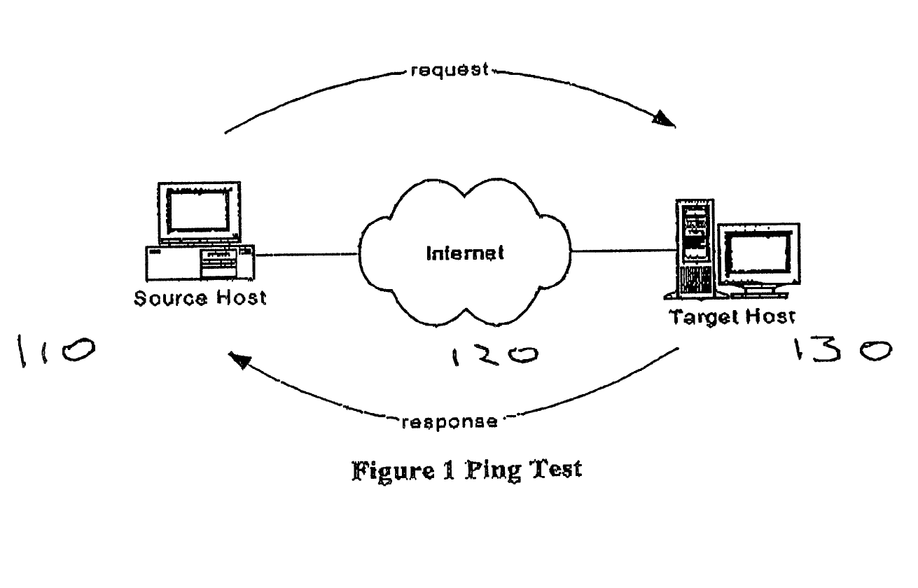

1. Ping: Hosts running the TCP/IP protocols will respond to a particular type of packets (often referred to as a ping packet) by immediately sending a response packet back to the sender. By measuring the time between sending a ping request and receiving a ping response, the network traffic condition between the monitor and monitored device can be obtained. FIG. 1 illustrates a ping process. A source host 110 initiates the ping process by sending a ping request to a target host 130. When the target host 130 receives the ping request, the target host 130 responds by sending a ping response back to the source host 110. By measuring the time required between the sending of the ping request and the receiving of the ping response, the monitor can measure the round trip time and packet loss rates.

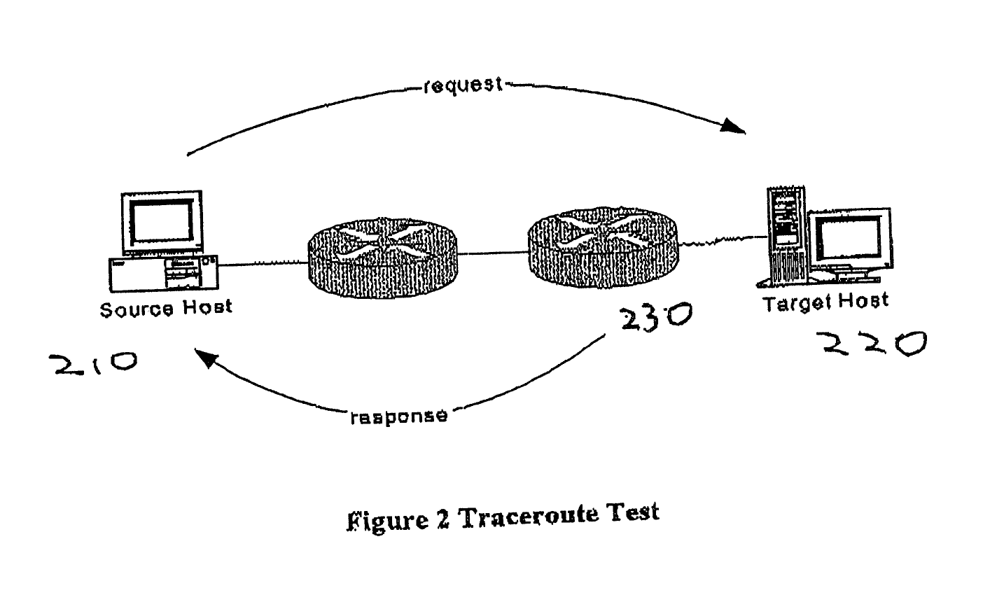

2. Traceroute: IP packets have a field called the “time to live.” This integer specifies the maximum number of times the packet can be forwarded before it must be dropped. When the data packet is dropped, the router that dropped it sends a notification back to the source. If the sender varies the time to live, it can identify the path through the network and the delay and loss rate to each hop on the path. FIG. 2 illustrates a traceroute process. A source host 210 sends a trace request to a target host 220 and then monitors the response received from the target host 220 or from any router 230 in between that dropped the data packet in order to determine the delay and loss rate to each hop on the path.

It should be noted that in the preferred embodiment as shown in FIG. 4, the active test can be recorded against internet address, port number, and/or subnets. Normally, a subnet is a large group of hosts with a single entry in the routing table. Therefore, this preferred embodiment is designed to characterize performance with routing table entries. While there are millions of hosts in the Internet, a typical routing table will only contain 50,000-100,000 subnets, a small number of which will be active at any given time. In general, the network manager is concerned with maintaining reliable connections to each subnet, not with the status of each remote host. However, the present invention is not limited to the characteristic performance by subnets, it can also manage the performance or IP ports and addresses. For example, the monitor can perform active tests to any ports and/or IP addresses in the Internet using the information provided by the flow records.

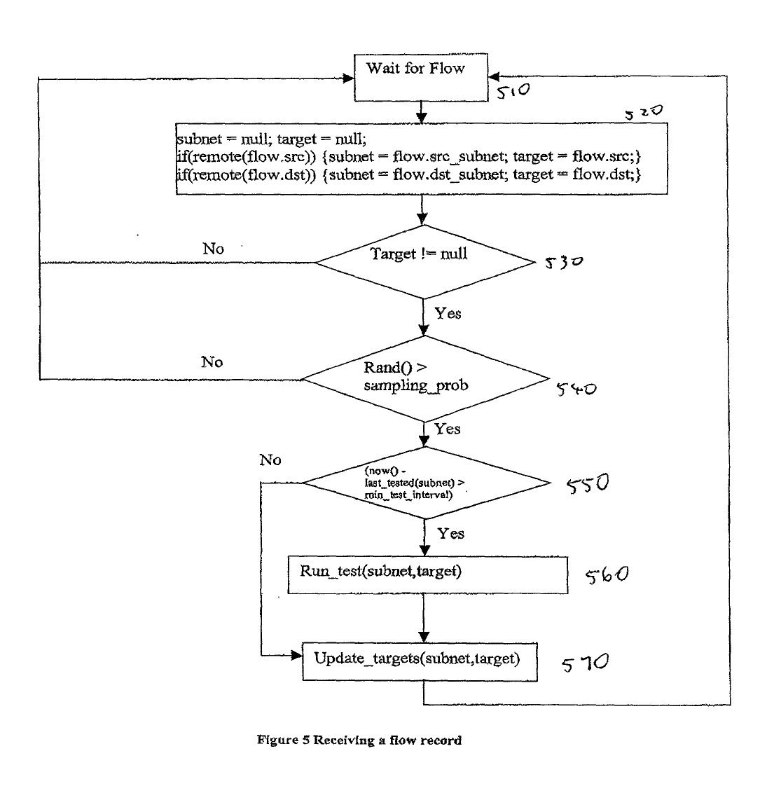

FIG. 5 shows details of a test scheduling algorithm according to the present invention. The monitor begins with the Wait state in Step 510. When the monitor receives a flow record, the monitor extracts the remote source and destination subnet and target information of the date packet from the flow record in Step 520. In Step 530, if the flow record does not contain any target information, the process will return to the Wait state. Otherwise, in Step 540, the filtered records are sampled so that a fraction of the records, determined by the parameter “sampling_prob”, is selected. In Step 550, the monitor checks whether any test has been performed within the previous min_test_interval seconds. If the monitor has not performed any test in the previous min_test_interval seconds, the monitor performs an active test to the target. Then the time of the test is recorded in Step 560. Finally, in Step 570, the monitor calls the update_targets( ) function to maintain a list of candidate targets for each subnet.

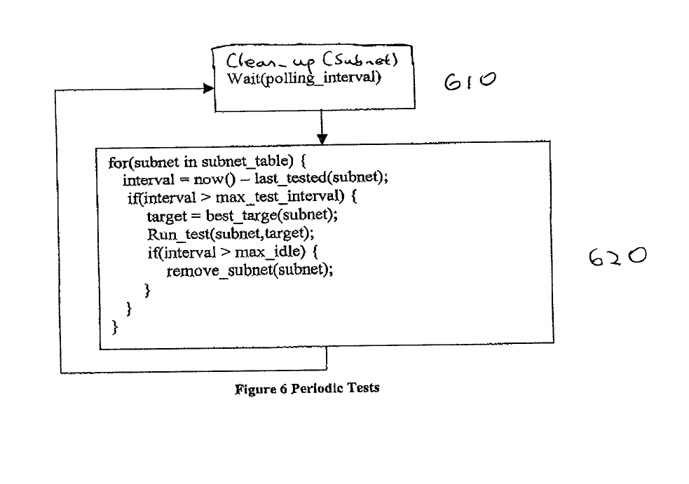

FIG. 6 shows a clean-up task running periodically in the monitor. In Step 610, the monitor clean-ups the subnet list every polling_interval seconds. The poll sweeps through the set of subnets, testing whether the subnets have been tested within max_test_interval seconds. If a subnet has not been seen in traffic for a period of max_idle seconds, it is removed for the list of subnets. Step 620.

It should be noted that the network monitoring system according to the present invention has the following advantages:

1. The monitor can automatically select the target web servers to perform an active test.

2. The active test performed coincides with user activities. Therefore, the test results will better measure the network traffic condition as seen by users.

3. By randomly selected the flow records for monitoring, the most active (important) paths can be tested most frequently.

4. The active test is efficient because the monitor only tests paths being used.

5. The active test correlates the characteristics of the links with the services that depend on them.

The present invention applies to a situation in which multiple computers are used to provide services to remote client PCs. This is typical of an Internet Service Provider. In this case, the filtering step selects flows between remote PCs and local servers.

Another application of the present invention applies to situation where access to remote servers needs to be managed. This is typical of many enterprise networks where client PC's are used to access remote services. In this case, the filtering step selects flows to important services (web and audio, etc.) and servers on remote sites.

Another application of this technology is to monitor local servers. Many companies provide a variety of different services over the Internet, including sales, support, training, etc. Providing these services may involve a large, ever changing number of servers. The filter can select flows to local servers and schedule appropriate tests. For example, simulating a web request to a local web server or an email request to a local mail server.

The foregoing description has been limited to a specific embodiment of this invention. It will be apparent, however, that variations and modifications may be made to the invention, with the attainment of some or all of the advantages of the invention. Therefore, it is the object of the appended claims to cover all such variations and modifications as come within the spirit and scope of the invention.

What is claimed is:

1. A method to monitor a network by a network monitor, comprising:
routing data packets through a router;
generating flow records for at least some of said data packets;
filtering said at least some of the flow records;
extracting packet information from the filtered flow records, wherein the extracted packet information comprises internet information of at least one target of interest; and
performing active measurements to said target of interest using the extracted packet information.

2. The method according to claim 1, said filtering step comprising:
selecting flow records based on an address field of said flow records.

3. The method according to claim 2, said filtering step comprising selecting flow records having destination or source of non-local hosts.

4. The method according to claim 2, said filtering step comprising selecting data packets having destination or source of local hosts.

5. The method according to claim 2, said filtering step comprising selecting flow records containing critical services based on the address field or a port field of the flow records.

6. The method according to claim 1, said filtering step comprising randomly selecting data packets from said filtered data packets.

7. The method according to claim 1, wherein said active measurements comprise a ping process.

8. The method according to claim 1, wherein said active measurements comprise a traceroute process.

9. The method according to claim 1, wherein said active measurements are selected based on said target of interest.

10. An apparatus for monitoring a network, comprising:
a router for routing data packets, wherein said router generates flow records for at least some of said data packets; and
a monitor for receiving the flow records, wherein said monitor filters said flow records, and further wherein said monitor extracts packet information from said filtered flow records, the extracted packet information comprising internet information of at least one target of interest, wherein said monitor performs active measurements to said target of interest using the extracted packet information.

11. The apparatus according to claim 10, wherein said monitor filters said flow records based on an address field of each flow record.

12. The apparatus according to claim 11, wherein said monitor selects flow records having destination or source of non-local hosts.

13. The apparatus according to claim 11, wherein said monitor selects flow records having destination or source of local hosts.

14. The apparatus according to claim 11, wherein said monitor selects data packets for critical services.

15. The apparatus according to claim 10, wherein said monitor randomly selects flow records from the flow records received by said monitor.

16. The apparatus according to claim 10, wherein said active measurements comprise a ping process

17. The apparatus according to claim 10, wherein said active measurements comprise a traceroute process.

18. The apparatus according to claim 10, wherein said active measurement are selected based on said target of interest.

19. A method to monitor a network by a network monitor, comprising:
routing data packets through a router;
generating flow records for at least a fraction of said data packets;
extracting packet information from at least a fraction of said flow records, wherein the extracted packet information comprises internet information of at least one target of interest; and
performing active measurements to said target of interest using the extracted packet information.

20. The method according to claim 19, said generating step comprising:
filtering said data packets; and
creating flows records for said filtered data packets.

21. The method according to claim 20, said extracting step comprising:
sampling said generated flow records; and
obtaining packet information from said sampled flow records.

22. The method according to claim 20, said filtering step comprising:
selecting flow records based on an address field of said flow records.

23. The method according to claim 20, said filtering step comprising selecting flow records having destination or source of non-local hosts.

24. The method according to claim 20, said filtering step comprising selecting data packets having destination or source of local hosts.

25. The method according to claim 20, said filtering step comprising selecting flow records containing critical services based on the address field or a port field of the flow records.

26. The method according to claim 19, wherein said active measurements comprise a ping process

27. The method according to claim 19, wherein said active measurements comprise a traceroute process.
